(19) United States
(12) Patent Application Publication
(10) Pub. No.: US 2015/0149260 A1
(43) Pub. Date: May 28, 2015

(54) CUSTOMER SATISFACTION PREDICTION TOOL

(71) Applicant: Brocade Communications System, Inc., San Jose, CA (US)

(72) Inventors: James Paul Martin, II, Vadnais Heights, MN (US); James Robbins, Boulder, CO (US); Matt Duster, Louisville, CO (US); Ryan Gorman, Denver, CO (US)

(73) Assignee: Brocade Communications System, Inc., San Jose, CA (US)

(21) Appl. No.: 14/088,156

(22) Filed: Nov. 22, 2013

(51) Int. Cl. G06Q 10/06

(52) U.S. Cl. CPC G06Q 10/06393
USPC 705/7.39

(57) ABSTRACT

A customer satisfaction prediction tool is usable to determine a point value for each of a plurality of leading and lagging service indicators associated with a plurality of service cases. The leading indicators may be based on currently open service cases and the lagging indicators may be based on closed service cases. The tool also is usable to add together the point values to produce a total point value, compute an index score based on the total point value, and display the computed index scores.

### BACKGROUND

Suppliers sell products for use by end users. For example, electronics companies provide electronics products such as computers, switches, etc. to end users which use such equipment in a data center. At times, the customer may experience a problem with the supplier's equipment, and when that happens, the customer contacts the supplier to remedy the problem. If enough problems occur and/or the problems are severe enough, the customer eventually will become dissatisfied with the supplier.

Suppliers tend to be reactionary in nature and, as such, react to problems raised by their customers. This reactive engagement process negatively impacts revenue and internal operational efficiency as a result of customer dissatisfaction.

### SUMMARY

This disclosure is generally directed to a tool that is usable to help proactively predict a satisfaction level of a customer. As a customer contacts a supplier of components used by the customer that are not operating as appropriate, the supplier begins to solve the customer's problems. The supplier tracks each problem as a “case” and various parameters for each case are determined and stored in a database. Such parameters include time stamp, severity level, case status, etc. Based on the database of parameters for each customer, a customer satisfaction tool calculates various key performance indicators, and computes an index score based on those indicators. The magnitude of the index score correlates to the satisfaction level of the customer. For example, a high index score (e.g., at or near 100%) may indicate that the customer is experiencing relatively few problems, that the problems that do occur are relatively minor, and that the problems are resolved relatively quickly by the supplier. A low index score, however, may indicate the opposite—for example, a dissatisfied customer, one who is experiencing numerous problems, problems that occur frequently, and that the problems are not resolved quickly by the supplier.

The customer satisfaction tool generates a graphical user interface (GUI) to show various customers and their computed index scores and how the scores have trended over time. This GUI provides a quick visual indication to the supplier as to customers that may become dissatisfied thereby permitting the supplier to take proactive steps such as contacting the customer to discuss issues that the supplier has observed happening.

One illustrative implementation is directed to a non-transitory, computer-readable storage device that includes software that, when executed by a processor, causes the processor to perform various operations. One such operation is to determine a point value for each of a plurality of leading and lagging service indicators associated with a plurality of service cases. The leading indicators are based on currently open service cases and the lagging indicators are based on closed service cases. Other operations are to add together the point values to produce a total point value, to compute an index score based on the total point value, and to display the computed index score.

Another illustrative implementation is directed to a method which includes determining a point value for each of a plurality of leading and lagging service indicators associated with a plurality of service cases. The leading indicators are based on currently open service cases and the lagging indicators are based on closed service cases. The method may also include adding together the point values to produce a total point value, computing an index score based on the total point value, and displaying the computed index score

### BRIEF DESCRIPTION OF THE DRAWINGS

For a detailed description of exemplary examples, reference will now be made to the accompanying drawings in which:

FIG. 1 illustrates the interaction between customer and supplier upon a customer detecting a problem with a component provided by the supplier;

FIG. 2 illustrates a system in accordance with various embodiments for implementing a customer satisfaction tool;

FIG. 3 illustrates a graphical user interface (GUI) produced by the customer satisfaction tool showing index score data by month for various customers in accordance with various embodiments;

FIGS. 4A-4B illustrate a GUI providing a breakdown of the index score data for a given time period for various customers in accordance with various embodiments; and

FIG. 5 illustrates a method for computing an index score for a customer in accordance with various embodiments.

### DETAILED DESCRIPTION

This disclosure is generally directed to a customer satisfaction tool usable by, for example, a supplier of components to customer. The components at issue here may be any type of product including, for example, non-electronic or electronic components such as switches, routers, computers, etc., but other types of components are possible as well. Supplied components may include hardware or software. The customer may be the purchaser and end-user of the components and the supplier may be the manufacturer or distributor of the components.

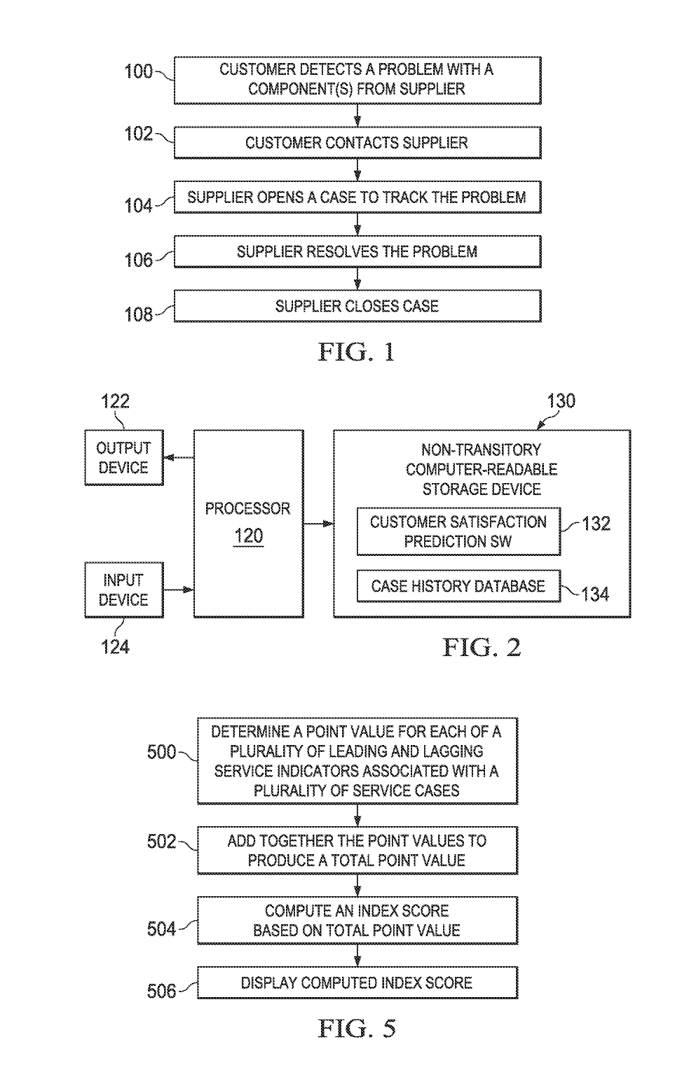

FIG. 1 illustrates the interaction between customer and supplier upon a customer detecting a problem with a component provided by the supplier. At 100, the customer detects a problem with a component provided by the supplier, and at 102 contacts the supplier about the problem. The problem could be any type of problem such as a malfunction of the component. At 104, the supplier opens a “case” to track the problem. A case is opened for each reported customer reported problem and may be generated and tracked in any suitable case tracking system (e.g., a spreadsheet, proprietary software, etc.). Eventually, the supplier resolves the problem at 106 and consequently closes the case at 108.

The process depicted in FIG. 1 may be repeated for each problem reported by the customer and for problems reported by all of the supplier's customers. For a given customer, a plurality of cases may be generated, and more than one case may be open at a time. The supplier assembles a database of information pertaining to the cases for the supplier's customers. The customer satisfaction tool described herein accesses the database of historical case data to generate an index score for each customer. In some embodiments, the index scores may range from low to high. A low index score for a particular customer may indicate that the customer has experienced enough problems or problems that are critical such that the customer, if not already dissatisfied, may become so in the very near future. A high index score may be indicative of a customer having relatively few problems, problems that are not critical, etc. A high index score indicates a customer that is likely to be satisfied. In other embodiments, a low index score may be indicative of a highly satisfied customer and a high index score indicative of a highly dissatisfied customer.

FIG. 2 shows an example of a system for implementation of the customer satisfaction tool. As shown, the illustrative system includes a processor 120 coupled to an output device 122 (e.g., a display) and an input device 124 (e.g., keyboard, mouse, etc.). A user may interact with the system via the input device 124 and the output device 122. The processor 120 also is coupled to a non-transitory computer-readable storage device 130. Storage device 130 may be implemented as volatile storage (e.g., random access memory) or non-volatile storage (e.g., hard disk drive, compact disc read only memory, solid state storage, etc.). The storage device 130 includes customer satisfaction prediction software 132 which is executable by the processor 120. Execution by the processor 120 of the customer satisfaction prediction software 132 preferably implements some or all of the functionality described herein. In some examples, the software may comprise a spreadsheet program. Any reference to a function performed by the customer satisfaction prediction software 132 includes processor 120 executing the software. The storage device 130 may also include a case history database 134. In some embodiments, the case history database 134 may be stored separate from the customer satisfaction prediction software 132. Also, in some embodiments, the software may be run locally to the database (i.e., on the same local area network) or remotely over a wide area network.

Each time a customer contacts the supplier about a problem, the supplier creates a case as noted above. For each such case, the supplier tracks various case-related parameters and stores such parameters in case history database 134. Software other than the customer satisfaction prediction software 132 may be used to track the cases and determine and store the case-related parameters to database 134. In some embodiments, the customer satisfaction prediction software 132 may be used to track the cases and store the parameters to the database.

The parameters tracked for each case include some or all of the following parameters:
Time Stamp Open
Time Stamp Closed
Severity level
Compliance With Service Level Agreement (SLA) (Initial Response)
Compliance With SLA (Ongoing Communication)
Status
Escalation to Highest Level Service Support Group

The Time Stamp Open and Time Stamp Closed parameters are generated and saved when the case is opened and closed, respectively. Each time stamp may be specified as a date and a time of day. The difference between the open and closed time stamps indicates how long the case is open, that is, its age which generally indicates how long it took for the supplier to resolve the problem.

The Severity Level codifies how important the problem is. In some embodiments, four severity levels are possible including low, medium, high and critical. A “low” severity level refers to a problem that is less important or mission critical than the other severity levels. At the other end of the spectrum is the “critical” severity level which indicates highly important problems, for example, problems which may be mission critical to the customer. Medium and high severity levels are in between low and critical. In other embodiments, other than four severity levels are possible. Further, labels other than textual labels are possible as well to specify the severity levels. For example, numbers (0, 1, 2, . . . ) can be used instead to specify the severity levels.

In general, a problem may be assigned an initial Severity Level but the assigned Severity Level may change as the problem is resolved by the supplier. For example, a case initially may be assigned a low Severity Level, but that Severity Level may increase to high or critical at a later point in time based on additional feedback from the client, reassessment of the underlying problem, etc. The Severity Level parameter may maintain a history of the severity levels for a given case.

Often, a supplier has various service level agreements (SLAs) with its customers. The SLAs may specify various contractual obligations to be performed by the supplier. One such SLA obligation is Compliance With SLA (Initial Response). This SLA requires the supplier to establish initial contact with the customer after opening a case within a contractually specified period of time. The period of time may be a function of the initially assigned Severity Level for the problem. For example, a supplier may have one week to contact the customer upon opening a case with a low Severity Level, but have only two hours to contact the customer upon opening a case with a critical Severity Level. The Compliance With SLA (Initial Response) parameter indicates whether or not the supplier has met this SLA obligation.

Another SLA may be the Compliance With SLA (Ongoing Communication). This SLA obligation requires periodic communications by the supplier to the customer with a frequency specified by the SLA. The frequency may be a function of the current Severity Level assigned to the case. For example, a supplier may be obligated to communicate with the customer once per week for a case having a low Severity Level, but communicate with the customer once per day for a case having a critical Severity Level.

The Status parameter indicates whether the case is currently open or closed. An open case is a case for which the underlying problem has not been resolved, and a closed case is a case for which the underlying problem has been resolved.

The supplier may have various technical support groups of differing capabilities. For example, the supplier may have a lowest level support group, a middle level support group and a highest level support group. The highest level support group is trained to solve the most difficult problems and the lowest level support group is trained to solve the simplest problems. A particular case may initially be assigned to the lowest level support group for resolution, but may have to be elevated to the middle level support group and even to the highest level support group as necessary. The Escalation to Highest Level Service Support Group parameter indicates whether the associated case has been assigned to the highest level service support group.

Any or all of the above-identified parameters for each case may be stored in the case history database 134. The database 134 may also additional parameters. Such additional parameters may include:
Total number of open cases per customer
Total number of closed cases per customer
Total number of cases per customer (open or closed)
Install base per customer

The total number of open, closed and combined cases per customer can be determined by examining the status parameter for all of the cases for each customer. The install base for a customer is indicative of the volume of components provided by the supplier to the customer. The install base may be specified, for example, in units of the number of components or in the monetary value of the components.

Based on the parameters listed above, the customer satisfaction prediction software 132 computes a plurality of key performance indicators, also referred to herein as service indicators. A point value is determined for each service indicator. For some service indicators, the point value is assigned while for other service indicators the point value is calculated. The service indicators include indicators in at least two categories including leading indicators and lagging indicators.

A leading indicator is an indicator based on currently open cases. In one example, leading indicators, described below, include some or all of the following:
Initial Severity A
Initial Severity B
Increase Severity A
Increase Severity B
Backlog Age
Time Since Last Modified (TSLM)
Cases per Asset
Initial Response
   A lagging indicator is based on closed cases. In an example, lagging indicators, also described below, include either or both of the following:
Escalation Rate
Time to Resolve

The Initial Severity A and Initial Severity B service indicators indicate the frequency with which cases are initially opened and assigned a Severity Level of A and B, respectively. For the example above in which the Severity Levels include low, medium, high and critical, A may correspond to critical and B may correspond to high. As such, the Initial Severity A (critical) service indicator may indicate the frequency with which cases are initialized to the critical Severity Level, while the Initial Severity B (high) service indicator may indicate the frequency with which cases are initialized to the high Severity Level.

Point values for the Initial Severity A service indicator are assigned based on percentile ranges. In one example, the maximum point value is 10. The percentile ranges may be 0-5%, 5-10%, 10-14%, and 15%. In this example, 10 points are assigned for a customer's Initial Severity A service indicator if, among all of that customer's cases, between 0 and 5% of cases are opened with an A (e.g., critical) Severity Level. A point value of 0 points may be awarded if 15+ % of that customer's cases are initialized to an A (e.g., critical) Severity Level. An example of the point value assignments is shown below:

Initial Severity A Point Assignments

| Percentile | 0-5% | 5-10% | 10-15% | 15+% |
|---|---|---|---|---|
| Point Value | 10 | 6 | 4 | 0 |

The point value assignments for the Initial Severity B (e.g., high) service indicator may be the same as for the Initial Severity A service indicator, or different as indicated in the table below. The point value assignments for the Initial Severity B service indicator preferably are based on the percentile breakdowns with which the customer's cases are open to the B (e.g., high) Severity Level.

Initial Severity B Point Assignments

| Percentile | 0-5% | 5-10% | 10-20% | 20+% |
|---|---|---|---|---|
| Point Value | 8 | 4 | 2 | 0 |

If a customer's cases are relatively infrequently (5% or less of all cases) opened to the A or B Severity Levels, then the maximum point value is assigned to both of these service indicators (e.g., 10 for the Initial Severity A service indicator and 8 for the Initial Severity B service indicator).

The Increase Severity A and Increase Severity B service indicators indicate the frequency with which cases have their severity levels increased to Severity Level A and B, respectively. For the example above in which the Severity Levels include low, medium, high and critical with A corresponding to critical and B corresponding to high, the Increase Severity A (critical) service indicator may indicate the frequency with which cases have their Severity Levels elevated to A (critical). Similarly, the Increase Severity B (high) service indicator may indicate the frequency with which cases have their Severity Levels elevated to B (high). Any case created with an initial Severity Level of A (e.g., critical) may be excluded from the total number of opportunities for both A (e.g., critical) and B (e.g., high) increases. Further, any case created with an initial Severity Level of high excluded from the number of opportunities for an increase to high.

Point values for the Increase Severity A and B indicators are assigned based on percentile ranges, with the point value assignments being the same or different between the Increase Severity A and Increase Severity B service indicators. In one example, for the Increase Severity A service indicator the maximum point value is 8. The percentile ranges may be 0-5%, 5-10%, 10-15%, and 15+ %. In this example, 8 points are assigned for a customer's Increase Severity A service indicator if, among all of that customer's cases, 0-5% of cases have their Severity Levels elevated to A (e.g., critical). A point value of 0 points may be awarded if 15+ % of that customer's cases are elevated to an A (e.g., critical) severity level.

An example of the point value assignments is shown below for the Increase Severity A service indicator.

Increase Severity A Point Assignments

| Percentile | 0-5% | 5-10% | 10-15% | 15+% |
|---|---|---|---|---|
| Point Value | 8 | 5 | 2 | 0 |

The point value assignments for the Increase Severity B (e.g., high) service indicator may be the same as indicated above in the table for the Increase Severity B indicator, or different. The point value assignments for the Initial Severity B service indicator is based on the percentile breakdowns with which the customer's cases have Severity Levels that are elevated to the B (e.g., high) severity level. If a customer's cases are relatively infrequently (5% or less of all cases) elevated to the B Severity Level, then the maximum point value (e.g., 6) is assigned to both of these service indicators.

An example of the point value assignments is shown below for the Increase Severity B service indicator.

Increase Severity B Point Assignments

| Percentile | 0-10% | 10-20% | 20+% |
|---|---|---|---|
| Point Value | 6 | 3 | 0 |

The Backlog Age service indicator indicates the average age (e.g., number of days) for a customer's open cases. The Backlog Age service indicator is determined by the customer satisfaction prediction software 132 based on the Status parameter for each of the customer's cases (which indicates which cases are still open) and on the age of each such case (e.g., determined by subtracting the Time Stamp Open parameter from the Time Stamp Closed parameter to compute the current age of the case). The customer satisfaction prediction software 132 averages the current ages of the various open cases for a given customer.

A point value is assigned to the customer's Backlog Age service indicator based on ranges of the average ages of open cases. In one example, the ranges may be 0-14 days, 14-22 days, 22-30 days, 30-40 days, and 40+ days. In this example, 7 points may be assigned to an average Backlog Age of 0-14 days while no points are assigned to an average Backlog Age that is greater than or equal to 40 days. The point value for each age range may be as follows:

Backlog Age Point Assignments

| Backlog Age | 0-14 | 14-22 | 22-30 | 30-40 | 40+ |
|---|---|---|---|---|---|
| Point Value | 7 | 5 | 4 | 2 | 0 |

The Time Since Last Modified (TSLM) service indicator indicates the percentage of cases for which the supplier complied with its ongoing communication SLA obligation. The ongoing communication obligation may be a function of a case's severity level. The customer satisfaction prediction software 132 determines this service indicator by examining the Compliance With SLA (Ongoing Communication) parameter for all of a customer's cases and computing the percentage of all such cases for which the Compliance With SLA (Ongoing Communication) parameter indicates the supplier was in compliance. The customer satisfaction prediction software 132 may assign a point value based on the following formula, although other formulas may be used as well:

TLSM point value=(1−(0.9−% compliance))*8

Where “% compliance” preferably is the percentage (in decimal form) of a customer's cases for which the supplier was in compliance with the ongoing communication SLA requirement. In this example, the % compliance variable in the formula above is 90% (0.9) for any compliance percentage that is 90% or greater. The maximum TLSM point value is 8 (for a compliance of 90% or greater) and the lowest point value is 0.8 (for a compliance of 0%—supplier never in compliance).

The Initial Response service indicator is indicative of the percentage of cases for which the supplier complied with its initial communication SLA obligation as reflected by the Compliance With SLA (Initial Response) parameter described above and tracked for each case. The customer satisfaction prediction software 132 may assign a point value based on the following formula, although other formulas may be used as well:

Initial Response point value=(1−(0.9−% compliance))*8

Where % compliance preferably is the percentage (in decimal form) of a customer's cases for which the supplier was in compliance with the initial communication SLA requirement. In this example, the % compliance variable in the formula above is 90% (0.9) for any compliance percentage that is 90% or greater. The maximum Initial Response point value is 8 (for a compliance of 90% or greater) and the lowest point value is 0.8 (for a compliance of 0%—supplier is never in compliance).

The Cases per Asset service indicator is indicative of the number of cases for a particular customer divided by that customer's install base. The number of cases may be the customer's total number of cases, either open or closed, or may be just the customer's total number of open cases. The table below provides one example of how point values are assigned to the Cases per Asset service indicator for a given customer.

Cases Per Asset Point Assignments

| Cases Per Asset | 0-0.0063 | 0.0063-0.01 | 0.01-0.15 | 0.15+ |
|---|---|---|---|---|
| Point Value | 3 | 2 | 1 | 0 |

The Escalation Rate service metric is indicative of the percentage of cases for a given customer that were escalated to the highest level service support group of the supplier. The customer satisfaction prediction software 132 determines this service indicator by examining the Escalation to Highest Level Service Support Group parameter for each of the customer's cases. A point value is assigned to the customer's Escalation Rate service metric based on various percentile ranks. One example of point value assignments for the Escalation Rate service metric is provided below.

Escalation Rate service metric point assignments

| Percentile | 0-10% | 10-20% | 20-30% | 30+% |
|---|---|---|---|---|
| Point Value | 3 | 2 | 1 | 0 |

The Time to Resolve service indicator is indicative of the average time to resolve a customer's cases. The average is computed for similar cases based on contractual and severity levels and percentile ranges are computed. In some embodiments, there may be a separate Time to Resolve service indicator for each severity level per an SLA. A point value is assigned for each percentile range according to a formula such as:

Time to Resolve service indicator point value=percentile*5

In some embodiments, for each customer the point values for each service indicator are determined and then added together to produce a total point value for that particular customer. The total point value is then divided by the total maximum point score which is the total point value that a customer could achieve (i.e., if the maximum point value was determined for each service indicator for the customer). The result (which may be multiplied by 100) is the index score for the customer.

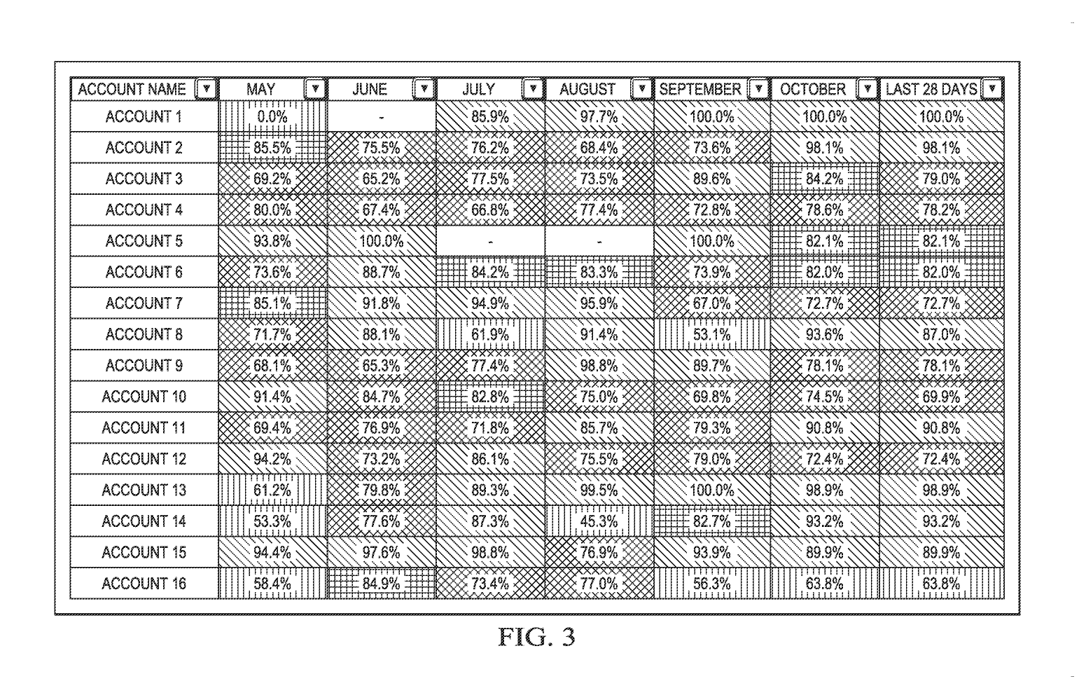

FIG. 3 shows an example of a graphical user interface (GUI) generated by the customer satisfaction prediction software 132. The GUI shown in FIG. 3 shows a plurality of customer accounts (Account 1-Account 16). For each account, the GUI includes the index score computed for each corresponding customer for each of multiple months (May-October in the example of FIG. 3) as well as the index score computed based on the data from the case history database 134 from the last 28 days.

The customer satisfaction prediction software 132 may render the shading in each cell of a particular color (illustrated in different cross hatching) dependent on the size of the index score to provide a quick visual for a user to detect undesirably low index scores. For example, red may be used for any index score below a threshold (e.g., 65%). Multiple colors may be used—each color used for index scores in a particular range of thresholds.

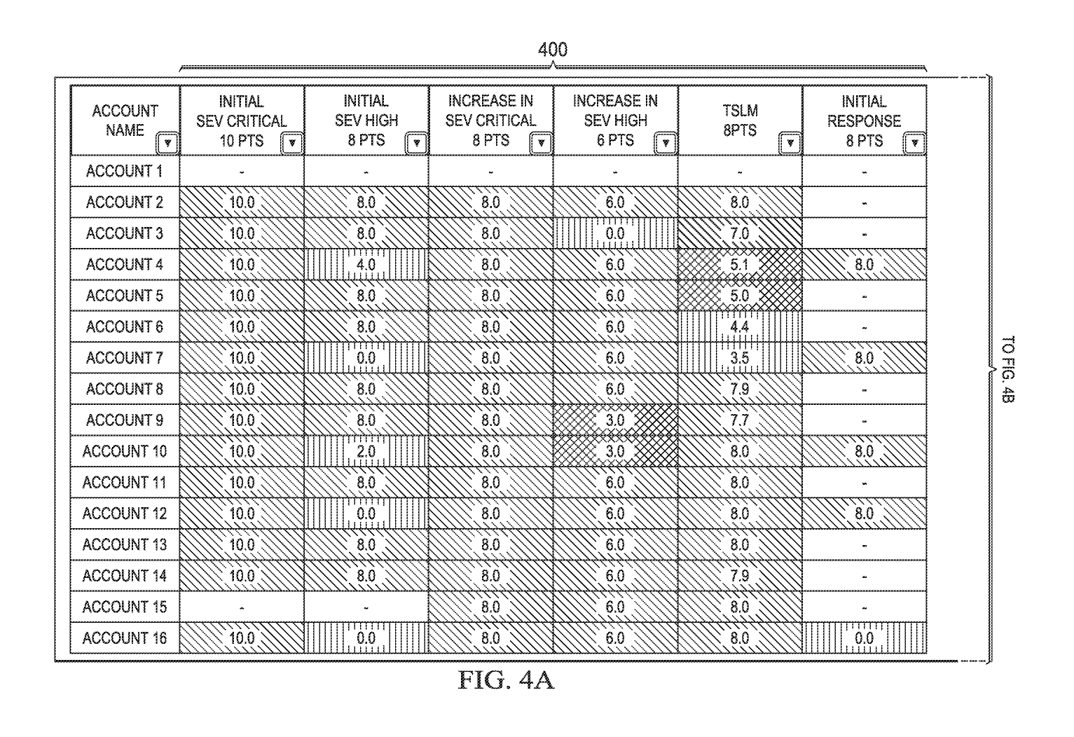

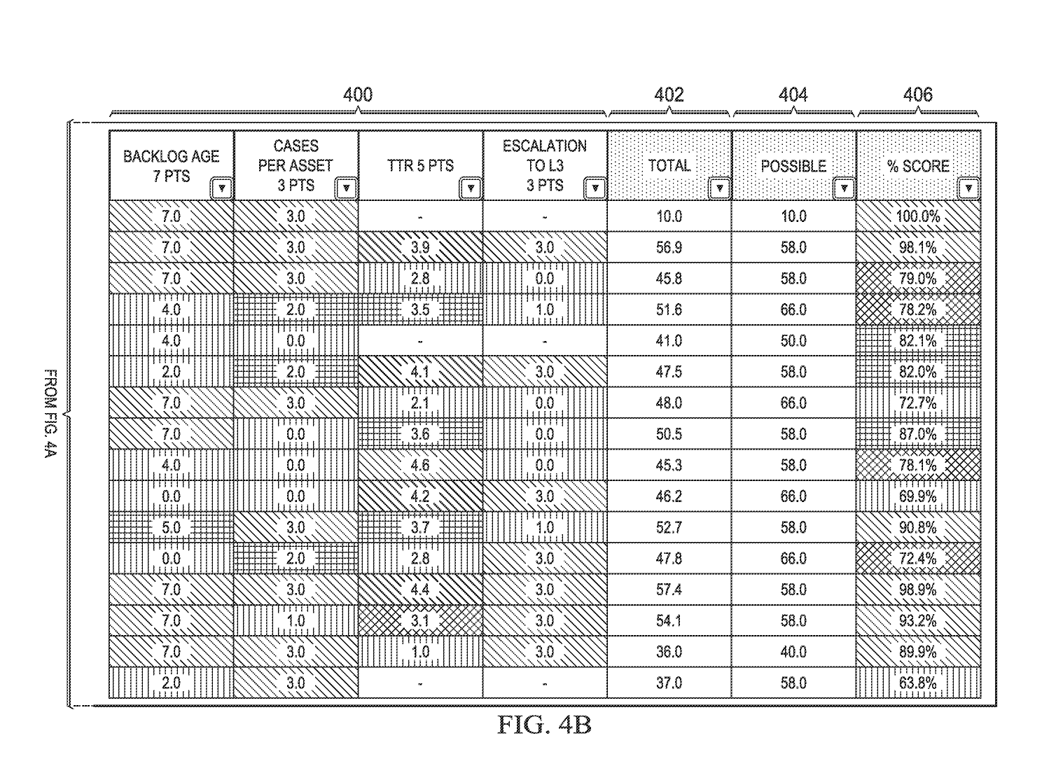

FIGS. 4A-4B show another example of a GUI generated by the customer satisfaction prediction software 132. For each customer, the illustrative GUI shown in FIGS. 4A-4B shows the breakdown of the most recently computed index score (e.g., the index score based on the last 28 days of data). The various leading and lagging service indicators discussed above are illustrated across the top of the GUI at 400 with the maximum number of points possible for each such service indicator. The column 402 labeled as “Total” shows the total point value for that customer based on the various service indicators used for that customer. Different customers may have different indicators used to calculate their index score per contract. The column 404 labeled as “Possible” shows the maximum possible point value for that customer based on the various service indicators used for that customer. Column 406 shows the index score for the customer which is the Total value in column 402 divided by the Possible value in column 404 and converted into a percentage value. As in the GUI of FIG. 3, different colors may be used to provide quick visual feedback to the user. Each color may indicate a different service indicator point level. For example, green may be used to render point values that are the maximum available for the corresponding service indicator, while red may be used to indicate a point value that is less than one-half of the maximum point value available for the given service indicator.

FIG. 5 illustrates a method that may be performed by the processor 120 executing the customer satisfaction prediction software 132. At 500, the method includes determining a point value for each of a plurality of leading and lagging service indicators associated with a plurality of service cases. The leading indicators preferably are based on currently open service cases and the lagging indicators based on closed service cases as explained above.

At 502, the method includes adding together the point values to produce a total point value, and at 504, the index score is computed based on the total point value. The resulting index scores then may be displayed on output device 122 at operation 506.

It will be appreciated that numerous variations and/or modifications may be made to the above-described examples, without departing from the broad general scope of the present disclosure. The present examples are, therefore, to be considered in all respects as illustrative and not restrictive.

What is claimed is:

1. A non-transitory, computer-readable storage device containing software that, when executed by a processor, causes the processor to:
determine a point value for each of a plurality of leading and lagging service indicators associated with a plurality of service cases, the leading indicators based on currently open service cases and the lagging indicators based on closed service cases;
add together the point values to produce a total point value;
compute an index score based on the total point value; and
display said computed index score.

2. The non-transitory, computer-readable storage device of claim 1 wherein the software, when executed, causes the processor to compute the index score by dividing the total point value by a total possible number of points for the leading and lagging indicators.

3. The non-transitory, computer-readable storage device of claim 1 wherein the leading indicators include at least one indictor selected from a group consisting of:
an initial severity indicator which indicates a percentage of cases that were opened a predetermined severity level;
an increase severity indicator which indicates a percentage of cases whose severity level is increased;
a backlog age indicator which indicates an average age of open cases;
a time since last modified (TSLM) indicator which indicates a percentage of cases for which a communication service level agreement (SLA) is met;
a cases per asset indicator which indicates the number of cases that have been created for a customer divided by an install base for that customer; and
an initial response indicator which indicates a percentage of cases for which an initial technical response SLA was met.

4. The non-transitory, computer-readable storage device of claim 1 wherein the lagging indicators include at least one of an escalation rate indicator and a time-to-resolve indicator, wherein the escalation rate indicator indicates the percentage of all closed cases that were escalated to a higher priority response group and wherein the time-to-resolve indicator indicates the average time to resolution of cases.

5. The non-transitory, computer-readable storage device of claim 1 wherein the software, when executed, causes the processor to generate and display values indicative of the index score over time.

6. A method, comprising:
determining a point value for each of a plurality of leading and lagging service indicators associated with a plurality of service cases, the leading indicators based on currently open service cases and the lagging indicators based on closed service cases;
adding together the point values to produce a total point value;
computing an index score based on the total point value; and
displaying said computed index score.

7. The method of claim 6 wherein the software, when executed, causes the processor to compute the index score by dividing the total point value by a total possible number of points for the leading and lagging indicators.

8. The method of claim 6 wherein the leading indicators include at least one indictor selected from a group consisting of:
an initial severity indicator which indicates a percentage of cases that were opened to a predetermined severity level;
an increase severity indicator which indicates a percentage of cases whose severity level is increased;
a backlog age indicator which indicates an average age of open cases;
a time since last modified (TSLM) indicator which indicates a percentage of cases for which a communication service level agreement (SLA) is met;
a cases per asset indicator which indicates the number of cases that have been created for a customer divided by an install base for that customer; and
an initial response indicator which indicates a percentage of cases for which an initial technical response SLA was met.

9. The method of claim 6 wherein the lagging indicators include at least one of an escalation rate metric and a time-to-resolve indicator, wherein the escalation rate indicator indicates the percentage of all closed cases that were escalated to a higher priority response group and wherein the time-to-resolve indicator indicates the average time to resolution of cases.

10. The method of claim 6 wherein the software, when executed, causes the processor to generate and display values indicative of the index score over time.
